(19) United States
(12) Patent Application Publication
(10) Pub. No.: US 2012/0323464 A1
(43) Pub. Date: Dec. 20, 2012

(54) MULTIPLE MODE THROTTLE CONTROL

(76) Inventors: Chad Christopher Steen, Holly Springs, NC (US); Bradley Paul Aldridge, Raleigh, NC (US); Jeremy Brandon Lambert, Raleigh, NC (US)

(21) Appl. No.: 13/164,094

(22) Filed: Jun. 20, 2011

(51) Int. Cl. F02D 41/00

(52) U.S. Cl. 701/103

(57) ABSTRACT

A multiple mode throttle control having a plurality of different modes to command the speed of a utility vehicle engine. The modes include a normal mode in which an electronic engine control unit commands engine speed to vary based on the position of the throttle pedal; a stationary mode in which the electronic engine control unit commands the engine to run at a fixed speed while the utility vehicle remains stationary based on a setting of an operator control connected to the electronic control unit; and a mobile mode in which the electronic engine control unit commands engine speed to vary while the utility vehicle is moving based on the position of the throttle pedal but not to exceed a maximum engine speed based on the setting of the operator control.

### FIELD OF THE INVENTION

This invention relates to a throttle control for a utility vehicle, and more specifically to a throttle control with multiple modes of operation to set the vehicle engine speed at a desired speed for operating a sprayer or other engine powered auxiliary device mounted on the utility vehicle.

### BACKGROUND OF THE INVENTION

Some utility vehicles may be equipped with a tank and pump for spraying liquids such as pesticides or herbicides on trees or other vegetation, or applying other materials in agricultural applications using auxiliary devices such as spreaders or top dressers. The sprayer pump or auxiliary device may be powered directly or indirectly by the utility vehicle's internal combustion engine. The spray volume or operation of an auxiliary device may change in accordance with changes in engine speed, but it may be desirable to maintain a consistent spray volume or constant vehicle and/or auxiliary pump speed. To maintain a constant engine speed while the vehicle is stopped or moving, the utility vehicle operator may try to hold the throttle pedal at a set position. Alternatively, a utility vehicle may be equipped with a mechanical linkage (or throttle governor control), that an operator may use to lock or fix the throttle pedal in a desired position to run the equipment at a constant or fixed engine speed.

However, known devices such as mechanical pedal interlock linkages have not been very satisfactory to maintain fixed engine speed for utility vehicles with sprayer pumps or other auxiliary devices. For example, mechanical pedal interlocks do not interact with the service or park brake, operator presence switch or transmission neutral position switch. As a result, there is a risk that an operator may try to set engine speed using a mechanical linkage while at least one of the interlocks is in the wrong position. Additionally, known devices such as mechanical pedal interlocks are not easy to use, install or operate.

A throttle control is needed for use with a utility vehicle having a sprayer pump or other auxiliary device powered by the utility vehicle engine that can function if the vehicle is stationary or moving. A throttle control is needed that interacts with safety interlocks on a utility vehicle such as a service or park brake, operator presence switch or transmission neutral position. A throttle control is needed for a utility vehicle with engine powered auxiliary devices such as a sprayer pump that is easy to use and relatively simple to operate.

### SUMMARY OF THE INVENTION

A multiple mode throttle control for a utility vehicle includes an operator control to set engine speed with an electronically controlled throttle. The modes include a normal mode having a variable speed based on a throttle pedal position; a stationary mode with a fixed speed regardless of the throttle pedal position; and a mobile mode with a variable speed based on throttle pedal position but not higher than a set maximum speed.

The operator controls may include a mode switch that may be actuated to run the engine at the fixed speed regardless of throttle pedal position, or to run the engine at a variable speed based on the throttle pedal position but not higher than the maximum speed. The multiple mode throttle control is intended for use with utility vehicles equipped with sprayers or other auxiliary devices powered by the engine and PTO, and provides ease of use and simplicity to operate the equipment at fixed engine speeds.

### BRIEF DESCRIPTION OF THE DRAWINGS

FIG. 1 is a perspective view of a utility vehicle equipped with a sprayer and pump, including the multiple mode throttle control according to a preferred embodiment of the invention.

FIG. 2 is a simplified schematic diagram of the multiple mode throttle control according to a preferred embodiment of the invention.

FIG. 3 is a state diagram of the multiple mode throttle control according to a preferred embodiment of the invention.

FIG. 4 is a chart showing engine speed in relation to throttle pedal position of the multiple mode throttle control in the mobile mode.

### DESCRIPTION OF THE PREFERRED EMBODIMENT

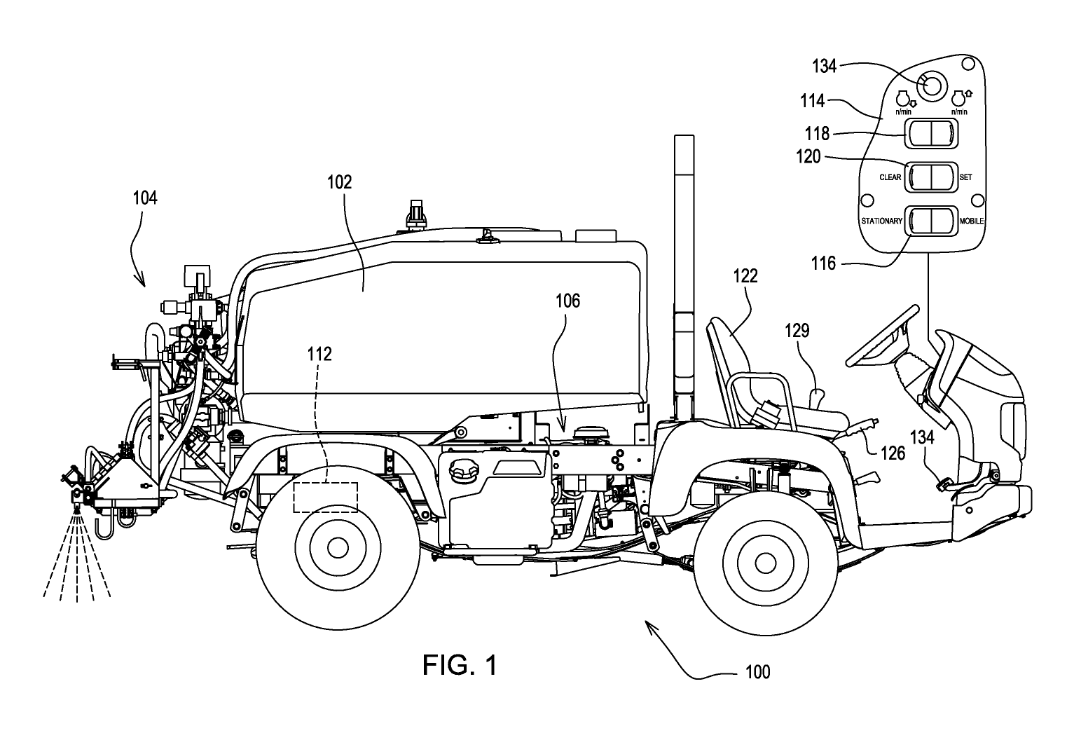

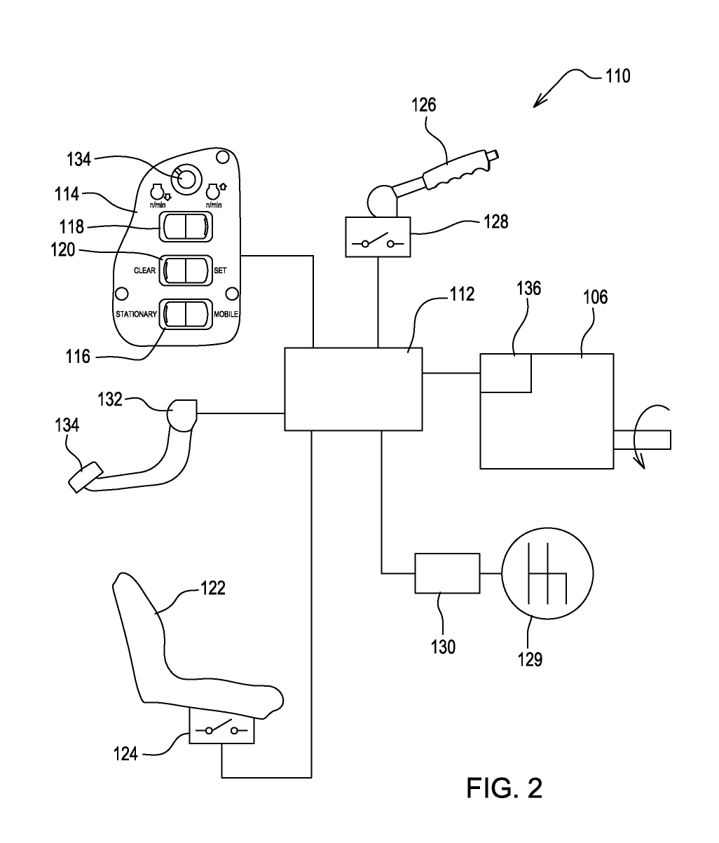

In a preferred embodiment shown in FIGS. 1 and 2, utility vehicle 100 may be equipped with tank 102 and pump 104 for spraying crops or other vegetation. The pump may be directly or indirectly connected to internal combustion engine 106, such as through a power take off (PTO). Alternatively, the utility vehicle may be equipped with an auxiliary device such as a top dresser or spreader that may be operated using a direct or indirect connection to the vehicle engine, typically through a PTO. The operator may control the engine speed (or RPM) using multiple mode throttle control 110.

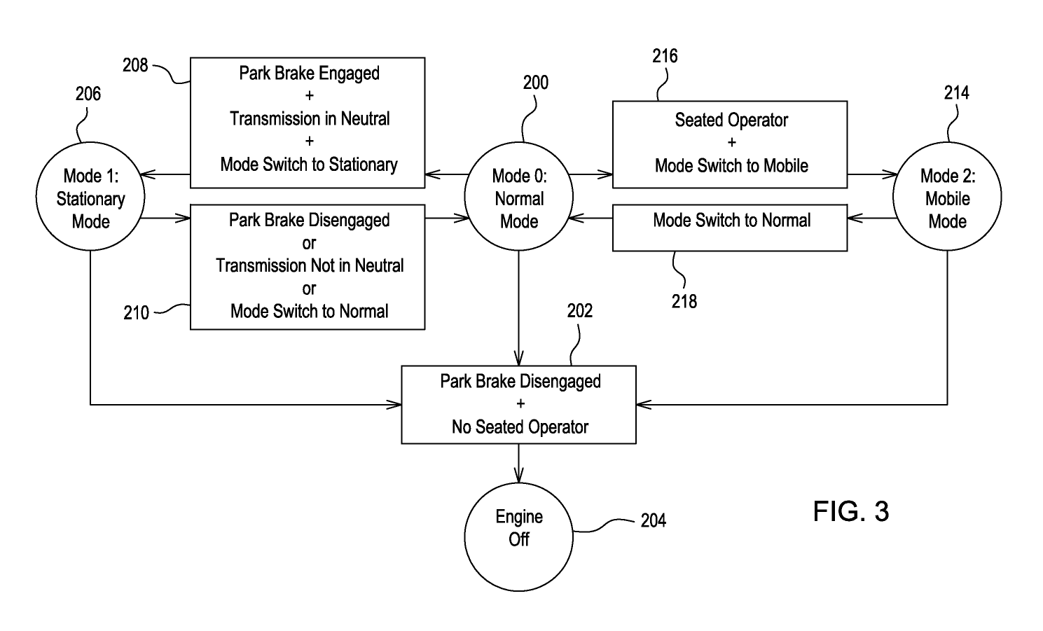

In one embodiment, multiple mode throttle control 110 may include electronic engine control unit 112 having programmed logic shown in the state diagram of FIG. 3. The electronic engine controller may use electronic inputs from operator controls 114 which may be a switch panel located in the utility vehicle operator station. The switches or controls on the operator controls may include: mode switch 116 that the operator may use to switch between each of the different operating modes; speed set switch 118 which may be a momentary switch the operator may use to increase or decrease the engine speed; and clear and set switch 120 which may be a momentary switch the operator may use to clear or set the engine speed. Each of these switches may provide discrete digital inputs (0 Vdc or 12 Vdc) to the electronic engine control unit.

In one embodiment, the electronic engine control unit also may receive electronic inputs from interlock switches through the vehicle electrical system. For example, operator seat 122 may have interlock switch 124 indicating if the operator is seated or not; park brake or service brake 126 with park brake interlock switch 128 indicating if the park brake is engaged or disengaged; and the utility vehicle transmission or shift lever 129 may have neutral sensor 130 indicating if the transmission is in neutral.

In one embodiment, the electronic engine control unit also may receive electronic input from position sensor 132 based on the position of accelerator or throttle pedal 134. The electronic engine control unit may command engine speed using electronically controlled throttle 136 as a proportional function of throttle pedal position in the first or “Normal” mode, and until the set maximum speed is reached in the “Mobile” mode. Additionally, the electronic engine control unit may use throttle pedal position to set the fixed or maximum speeds through the electronically controlled throttle in the “Stationary” and “Mobile” modes.

In one embodiment, the multiple mode throttle control may provide three distinct operational modes. The first or Normal mode (shown as Mode 0 in FIG. 3, with reference number 200) may be the default mode for the multiple mode throttle control. For example, the Normal mode may be the mode of operation at start up of the utility vehicle, when it is not necessary to maintain a fixed engine speed, such as when spray or other auxiliary equipment is off. To operate in the Normal mode, mode switch 116 is not actuated, or is in the off position. In the Normal mode, the electronic engine control unit may command engine speed to track the position of the foot throttle or accelerator pedal between a low idle speed and a maximum speed as the foot operated throttle pedal moves in an operating range between its physical stops.

In one embodiment, as shown by reference number 202 in FIG. 3, while operating in the Normal mode, if park brake interlock switch 128 is released and operator presence switch 124 indicates there is no seated operator, the electronic control unit may shut off the engine in block 204, for example by terminating ignition or fuel supply to the engine.

In one embodiment, a second or “Stationary” mode 206 is represented as Mode 1 in FIG. 3. For example, the Stationary mode may be used while the utility vehicle is parked and the operator needs to use a hand sprayer or other auxiliary device powered by the PTO at a consistent flow rate. As shown by reference number 208 in FIG. 3, to change the multiple mode throttle control from the Normal Mode to the Stationary mode, the electronic engine control unit must receive independent inputs from the transmission neutral sensor 130, park brake interlock switch 128 and mode switch 116. The transmission neutral sensor must be in the neutral position, the park brake interlock switch must be in the engaged position, and the mode switch must be in the Stationary mode position. Once these switches are in the specified positions, the operator may set the engine speed at a fixed speed.

In one embodiment, the multiple mode throttle control may include stationary speed control 135 that the operator may use to set a fixed engine speed in the Stationary mode. The stationary speed control may be an adjustable secondary throttle such as a rotary potentiometer that provides an electrical signal to the electronic control unit to run the engine at the setting specified by the operator.

Alternatively, the operator may set the engine speed at a fixed speed in the Stationary mode by depressing throttle pedal 134 to a desired position, and then momentarily moving the clear and set switch 120 to the set position. The electronic engine control unit will command the engine to run at this fixed speed regardless of throttle pedal position. The operator may discontinue the fixed engine speed in the Stationary mode by momentarily moving the clear and set switch to the clear position, returning the engine speed to low idle.

In one embodiment, as shown by reference number 210 in FIG. 3, while operating in the Stationary mode, if the park brake is disengaged, the transmission is shifted out of neutral, or the mode switch is moved out of the stationary mode position, the electronic engine control unit may exit the Stationary mode and return to the Normal mode. This returns the engine to a speed corresponding to the throttle pedal position, instead of the fixed speed. However, the fixed engine speed in the Stationary mode may continue to be stored in the electronic engine control unit. Additionally, as shown by reference number 202 in FIG. 3, while operating in the Stationary mode, if the park brake is disengaged and the operator presence switch indicates there is not a seated operator, the electronic engine control unit may shut off the engine in block 204.

In one embodiment, a third or “Mobile” mode 214 is shown as Mode 2 in FIG. 3. The Mobile mode may be used for spraying, top dressing, or operation of other auxiliary equipment while the utility vehicle is moving using its traction drive. As shown by reference number 216, to change from the Normal mode to the Mobile mode, the operator presence switch must indicate a seated operator, and the mode switch must be in the Mobile mode position.

In one embodiment, to set the maximum engine speed in the Mobile mode, the operator may move the throttle pedal to the desired maximum speed and then momentarily move clear and set switch 120 to the set position. This causes the electronic engine control unit to set and store the current engine speed as the setting for the maximum engine speed in the Mobile mode.

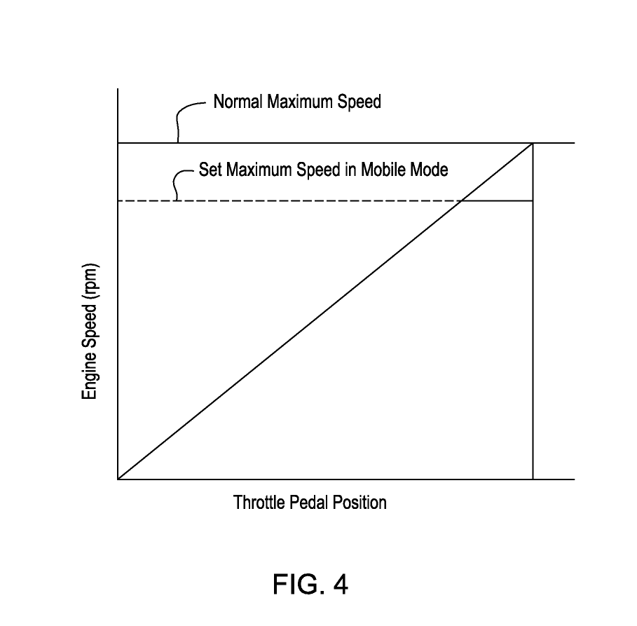

In one embodiment, in the Mobile mode, the electronic engine controller may command the engine speed to track the position of the foot throttle pedal up to the set maximum speed and no higher, as shown in the diagram of FIG. 4 which illustrates engine speed in relation to throttle pedal position. As shown in FIG. 4, the electronic engine control unit may command the engine to run at a speed that is a proportional function of the position of the foot pedal throttle or accelerator, until the engine reaches the set maximum speed. The operator may hold the foot pedal to the floor but the electronic engine control unit will not allow the engine to exceed the set maximum speed. The operator need not hold the foot pedal at an intermediate position corresponding to the desired maximum speed.

In one embodiment, the electronic engine control unit may continue to store the set maximum engine speed in the Mobile mode even after shutdown or discontinued operation of the utility vehicle. Thus, when vehicle operation resumes in the Mobile mode, the electronic engine control unit may again prevent the engine from exceeding this set maximum engine speed. Additionally, the electronic engine control unit may command the engine to slow down to the set maximum engine speed if the operator moves the mode switch to the Mobile mode position while the vehicle is exceeding the set maximum engine speed.

In one embodiment, the operator may cancel or clear the set maximum engine speed in the Mobile mode by momentarily moving the clear and set switch to the clear position. However, to prevent the engine from speeding up unexpectedly in the Mobile mode, the electronic engine control unit may not recognize the clear command from the clear and set switch unless the foot or throttle pedal is in the low idle position.

In one embodiment, as shown by reference number 218 in FIG. 3, the electronic engine control unit may exit the Mobile mode and return to the Normal mode by using the mode switch. Additionally, as shown in block 202 in FIG. 3, while operating in the Mobile mode, if the park brake is disengaged and the operator presence switch indicates there is not a seated operator, the electronic engine control unit may shut off the engine in block 204.

Having described the preferred embodiment, it will become apparent that various modifications can be made without departing from the scope of the invention as defined in the accompanying claims.

1. A multiple mode throttle control, comprising:
an electronic engine control unit connected to a throttle pedal position sensor of a utility vehicle engine and having a plurality of different modes to command the speed of the engine of a utility vehicle, including:
a normal mode in which the electronic engine control unit commands engine speed to vary based on the throttle pedal position sensor;
a stationary mode in which the electronic engine control unit commands the engine to run at a fixed speed while the utility vehicle remains stationary based on a setting of an operator control connected to the electronic control unit; and
a mobile mode in which the electronic engine control unit commands engine speed to vary while the utility vehicle is moving based on the throttle pedal position sensor but not to exceed a maximum engine speed based on the setting of the operator control.

2. The multiple mode throttle control of claim 1 wherein the utility vehicle includes a sprayer pump having a flow rate based on the engine speed.

3. The multiple mode throttle control of claim 1 wherein the operator control includes a clear and set switch that may be momentarily actuated to clear or set the maximum engine speed in the mobile mode.

4. The multiple mode throttle control of claim 1 further comprising a park brake switch connected to the electronic engine control unit, the park brake switch indicating that the park brake is engaged for the electronic engine control unit to command the engine to run in the stationary mode.

5. The multiple mode throttle control of claim 1 further comprising a neutral sensor connected to the electronic engine control unit, the neutral sensor indicating a transmission is in neutral for the electronic engine control unit to command the engine to run in the stationary mode.

6. The multiple mode throttle control of claim 1 further comprising an operator presence switch connected to the electronic engine control unit that must indicate a seated operator for the electronic engine control unit to command the engine to run in the mobile mode.

7. A multiple mode throttle control, comprising:
an operator control setting a utility vehicle engine speed with an electronically controlled throttle in a first mode at a variable speed based on a throttle pedal position; or in a second mode at a fixed speed regardless of the throttle pedal position if the transmission of the utility vehicle is in neutral and a park brake is engaged; or in a third mode at a variable speed based on the throttle pedal position but not higher than a set maximum speed.

9. The multiple mode throttle control of claim 8, wherein the operator control includes a mode switch that is actuated to run the engine in the second mode at the fixed speed regardless of throttle pedal position, or in the third mode to run the engine at a variable speed based on the throttle pedal position but not higher than the maximum speed.

10. The multiple mode throttle control of claim 8, wherein the operator control includes a clear and set switch to set the maximum speed.

11. The multiple mode throttle control of claim 8 wherein the utility vehicle includes a sprayer pump.

12. A multiple mode throttle control, comprising:
an electronic engine control unit connected to a utility vehicle engine and controlling speed of the engine; the utility vehicle having a sprayer pump powered by the engine through a power take off;
operator controls connected to the electronic engine control unit for an operator to select between at least two modes of operation, to set and clear a fixed speed in one of the modes, and to set and clear a maximum speed in another of the modes; and
a plurality of safety interlocks connected to the electronic engine control unit and limiting which of the modes may be used.

13. The multiple mode throttle control of claim 12, wherein the safety interlocks include an operator presence switch, a park brake engagement switch, and a transmission neutral sensor.

14. The multiple mode throttle control of claim 12, further comprising a throttle pedal and throttle pedal position sensor connected to the electronic engine control unit, the throttle pedal being disabled if a fixed speed is set in one of the modes.

15. The multiple mode throttle control of claim 12, further comprising a throttle pedal and throttle pedal position sensor connected to the electronic engine control unit, the engine speed based on throttle pedal position up to the set maximum speed at which point the throttle pedal position cannot increase engine speed.
